(19) United States
(12) Patent Application Publication
(10) Pub. No.: US 2005/0104408 A1
(43) Pub. Date: May 19, 2005

(54) Photochromic Automobile window sunshade

(75) Inventor: Robert E. Capps, Santa Rosa Beach, FL (US)

Correspondence Address: STEVEN C. SCHNEDLER;CARTER SCHNEDLER & MONTEITH, PA, 56 CENTRAL AVE., SUITE 101, PO BOX 2985, ASHEVILLE, NC, 28802, US

(73) Assignee: Blue Ridge International Products Company, Freeport, FL (US)

(21) Appl. No.: 10/992,172

(22) Filed: Nov. 17, 2004

Related U.S. Application Data
(60) Provisional application No. 60/520,850, filed on Nov. 17, 2003.

(51) Int. Cl. B60J 3/00

(52) U.S. Cl. 296/97.7

(57) ABSTRACT

Sunshades for automobile windows, particularly for shading an infant riding in a child car safety seat from the rays of the sun. A vehicle sunshade includes a sheet of generally transparent flexible shading material which either self-adheres to the interior side of a vehicle window, or which has an attachment for attaching the sheet of generally transparent flexible shading material to the interior side of a vehicle window. The sheet of shading material has a photochromic characteristic such that the sunshade turns relatively darker when exposed to sunlight and relatively lighter or more transparent when the intensity of sunlight decreases.

### CROSS-REFERENCE TO RELATED APPLICATION

The benefit of U.S. Provisional Patent Application Ser. No. 60/520,850, filed Nov. 17, 2003, is claimed.

### BACKGROUND OF THE INVENTION

The invention relates to sunshades for automobile windows, particularly for shading an infant riding in a child car safety seat from the rays of the sun.

Several types of automobile sunshades which generally attach to a vehicle side window particularly for shading infants and small children from the rays of the sun are currently available. Such sunshades typically are made of transparent plastic, and have partially transparent images printed thereon. The images serve the dual purposes of partially blocking the rays of the sun, while providing visual stimulation and possibly entertainment for a child or an infant, in addition to allowing at least partial viewing through the vehicle side window.

### SUMMARY OF THE INVENTION

In one aspect, a vehicle sunshade is provided which includes a sheet of generally transparent flexible shading material which self-adheres to the interior side of a vehicle window. The sheet of shading material has a photochromic characteristic such that the sunshade turns relatively darker when exposed to sunlight and relatively lighter or more transparent when the intensity of sunlight decreases.

In another aspect, a vehicle sunshade is provided which includes a sheet of generally transparent flexible shading material and an attachment for attaching the sheet of generally transparent flexible shading material to the interior side of a vehicle window. The sheet of shading material has a photochromic characteristic such that the sunshade turns relatively darker when exposed to sunlight and relatively lighter or more transparent when the intensity of sunlight decreases.

### BRIEF DESCRIPTION OF THE DRAWINGS

FIG. 1 depicts the invention embodied in a static cling type automobile sunshade;

FIG. 2 depicts the invention embodied in a roller shade type automobile sunshade;

FIG. 3 depicts the invention embodied in a pop-open type automobile sunshade;

FIG. 4 is an enlarged cross-sectional view representing any one of the sunshade embodiments of FIGS. 1, 2 or 3, depicting a specific structure comprising a photochromic film printed on a surface of the sunshade shading material; and

FIG. 5 is an enlarged cross-sectional view, also representing any one of the sunshade embodiments of FIGS. 1, 2 or 3, depicting another specific structure wherein photochromic characteristics are incorporated within the plastic material itself of the sunshade shading material.

### DETAILED DESCRIPTION

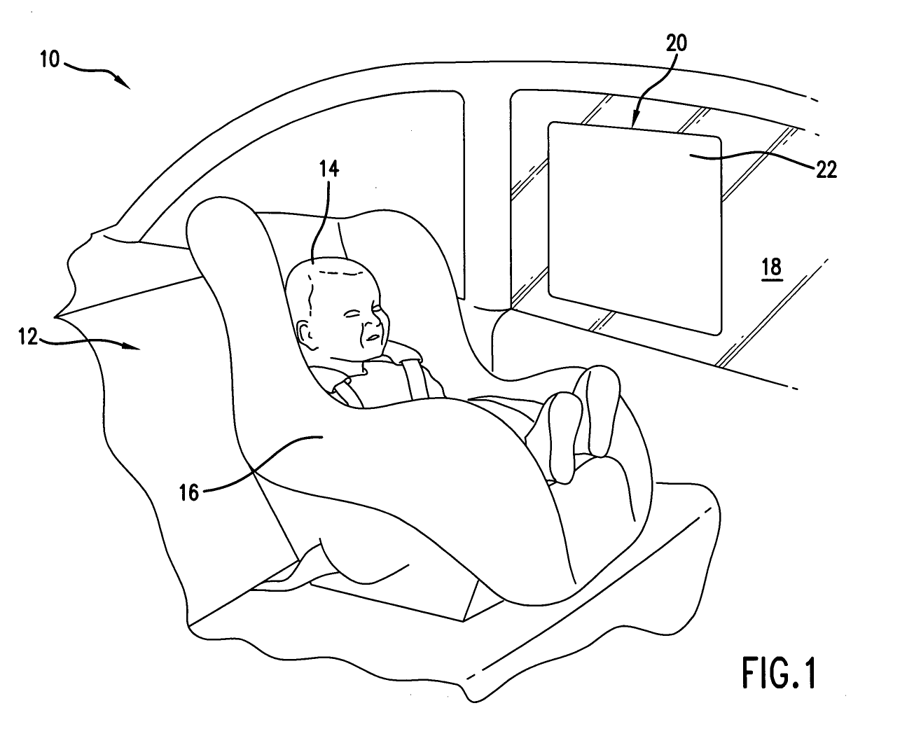

Referring first to FIG. 1, an automobile or other vehicle is generally designated 10, and is represented by an interior 12. Within the automobile interior 12, an infant 14 is seated within a child safety car seat 16 located in a rear seat of the vehicle.

The vehicle 10 has a side window 18 to which a sunshade 20 (which also may be referred to as a sunscreen 20) embodying the invention is attached. As an alternative, the sunshade 20 may be attached to the rear window (not shown) of the vehicle 10. In the FIG. 1 embodiment, the sunshade 20 is of the static cling type, and generally comprises shading material 22, in the form of a sheet of flexible plastic which self-adheres directly to the automobile side window 18 by means of static cling forces, and may easily be removed or “peeled off” at any time. The sunshade 20 is accordingly positioned so as to at least partially block the rays of the sun which otherwise would directly shine on the infant 14.

The sunshade 20 has a photochromic characteristic (which may alternatively be referred to as “photochromatic” or “photosensitive”). More particularly, the sunshade 20 turns darker when exposed to sunlight, and lighter or more transparent when the intensity of sunlight decreases. Thus, the shading effect is automatically regulated in accordance with sunlight conditions. When bright sunlight is shining through the automobile side window 18, the sunshade 20 embodying the invention darkens, thereby providing more shading of the infant 14 from the sun's rays. Under other conditions, such as when the sun is not directly shining through the vehicle side window 18, the sunshade 20 lightens or becomes more transparent, minimizing a potentially undesirable darkening effect under such conditions, and facilitating viewing out through the automobile side window 18.

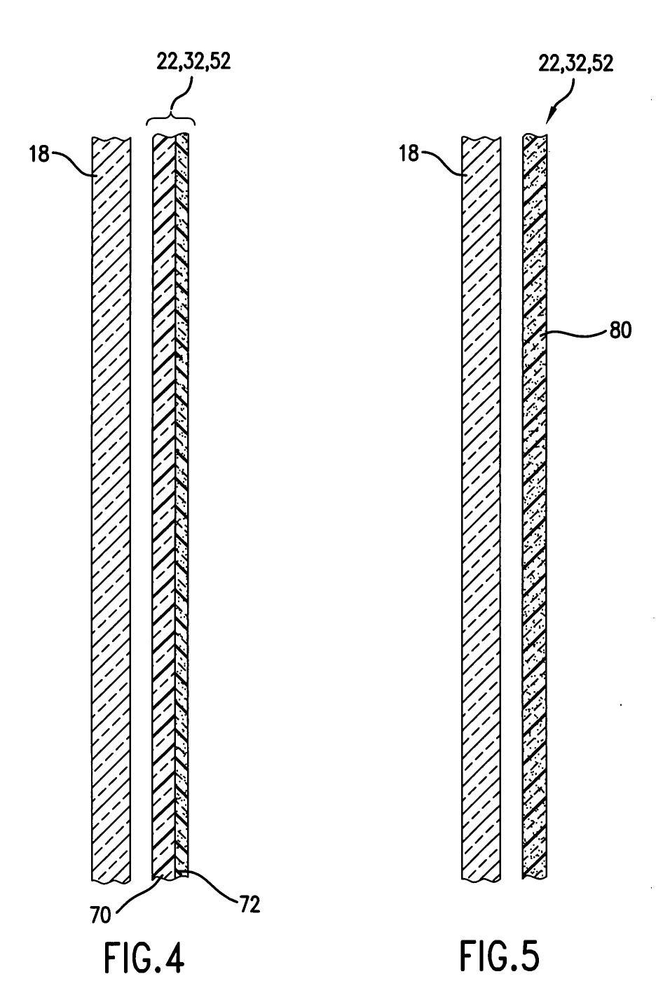

A variety of technologies may be employed to achieve the photochromic characteristic, and two specific structures are described hereinbelow with reference to FIGS. 4 and 5. As examples, photochromic eyeglasses are well known (which may also be referred to as “photochromatic” or “photosensitive”), which automatically darken to function as sunglasses when the wearer is in bright sunlight. Photochromic window glass is also known. Thus, the same or any similar technology, either presently known or hereinafter discovered, which produces a darkening characteristic in the presence of sunlight may be employed in embodiments of the invention.

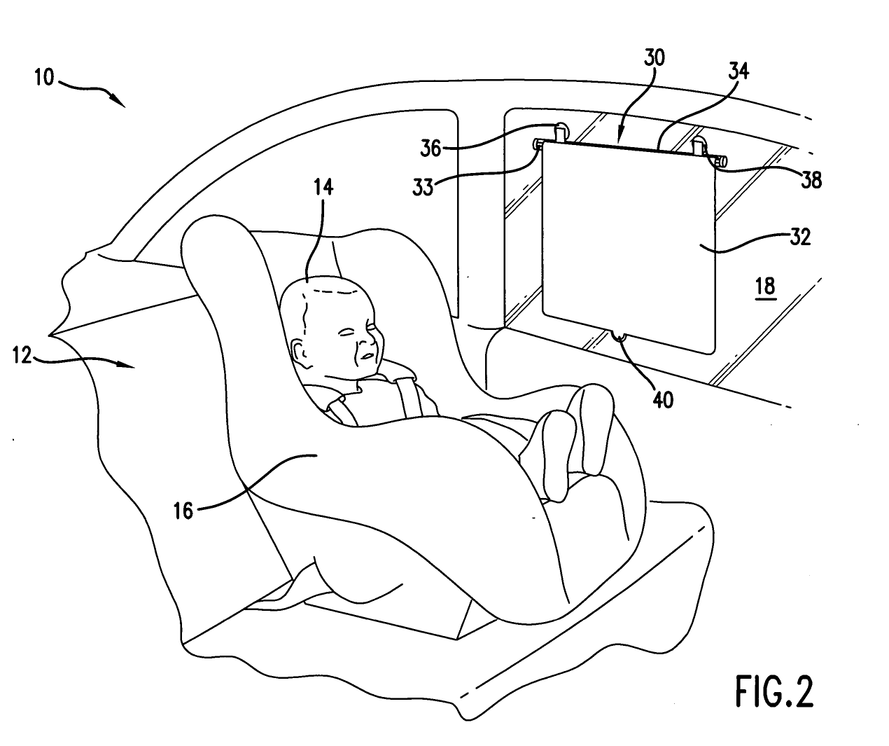

Referring next to FIG. 2, another sunshade 30 embodying the invention is shown, in the form of a roller shade 30. Environmental aspects, in particular the infant 14 in the child safety car seat 16 are the same as in FIG. 1, as well as the window 18 to which the sunshade 30 is attached. Likewise, the roller shade 30 has a photochromic characteristic as is described above with reference to FIG. 1.

The roller shade 30, other than the photochromic characteristic, is of conventional construction and includes shading material 32 in the form of a sheet 32 of flexible plastic which retracts by rolling up around a spindle 33 supported by a mounting bracket 34, with an associated spring winding mechanism (not shown). The mounting bracket 34 is attached to the automobile side window 18 by means of a pair of suction cups 36 and 38. A bottom tab 40 may be included to prevent the shading material 32 of the roller shade 30 from flapping.

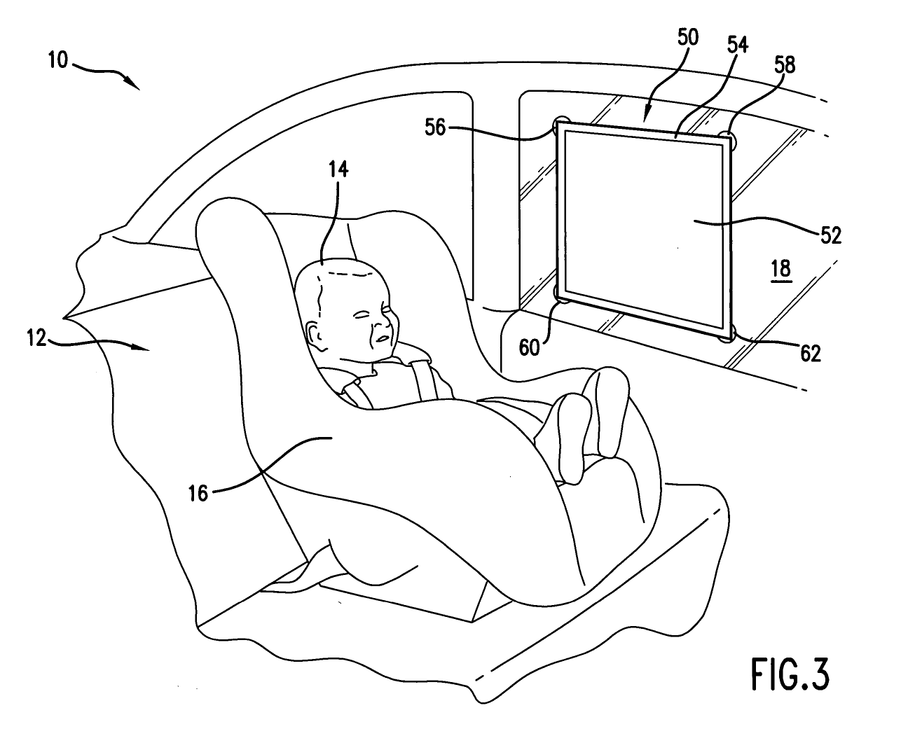

Referring next to FIG. 3, yet another sunshade 50 embodying the invention is shown, in the form of a pop-open shade 50, likewise in the environment of the automobile interior 12 within which there is the infant 14 seated in the child safety car seat 16. The pop-open shade 50 is generally mounted to the automobile side window 18.

The pop-open shade 50 in general is of conventional construction and includes the actual shading material 52, in the form of a thin sheet 52 of transparent plastic. However, unlike prior art pop-open sunshades, the shading material 52 also has photochromic characteristics. The shading material 52 is surrounded by a snap action border 54 which folds up for convenient storage, and yet snaps open to form a relatively rigid frame. The snap action border 54 is attached to the side window 18 at its four corners by means of suction cups 56, 58, 60 and 62.

As an alternative to the side window attachment of FIGS. 1, 2 or 3, any one of the sunshades 20, 30 or 50 may be attached to the automobile 10 rear window (not shown), particularly for shading an infant in a rear facing child safety car seat.

Referring next to FIG. 4, represented is one particular structure which may be employed in any one of the sunshade embodiments 20, 30 or 50 of FIGS. 1, 2 or 3. In FIG. 4, the vehicle side window 18 is shown in cross section, as is the shading material 22, 32 or 52 of either FIG. 1, FIG. 2 or FIG. 3 immediately adjacent thereto on the side of the side window 18 glass (or the rear window glass) which is inside the automobile 10. In FIG. 4, the shading material 22, 32 or 52 is shown slightly spaced from the automobile side window 18, as is likely the case of either the FIG. 2 roller shade or the FIG. 3 pop-open configuration. It will be understood that, in the case of the FIG. 1 static cling sunscreen embodiment 20, the automobile side window 18 and the shading material 22 are in direct contact with each other, and the gap visible in FIG. 4 is accordingly not present.

The shading material in FIG. 4 more particularly comprises a flexible, transparent plastic sheet 70, for example made of polyvinyl chloride (PVC), approximately 0.0105 inches in thickness. A photochromic film 72 is applied to a surface of the plastic sheet 60 employing, for example, a printing process. It will be appreciated, however, that other processes may be employed for applying the photochromic film including, as another example, direct lamination.

It is the photochromic film 72 which imparts the photochromic characteristics (which, again, may also be referred to as “photochromatic” or “photosensitive”), resulting in the functionality and benefits described hereinabove with reference to FIG. 1.

Referring finally to FIG. 5, represented is another structure which may be employed in any one of the sunshade embodiments 20, 30 or 50 of FIGS. 1, 2 or 3.

Again, in FIG. 5, the automobile side window glass 18 is shown, with the shading material 22, 32 or 52 on the inside thereof. Alternatively, the shading material 22, 32 or 52 may be on the inside of the automobile rear window (not shown). As noted above with reference to FIG. 4, in the case of the FIG. 1 static cling sunscreen embodiment 20, there is no gap between the automobile side window 18 and the shading material.

In the FIG. 5 structure, the shading material 22, 32 or 52 more particularly comprises a photochromic plastic sheet 80, also generally comprising a flexible plastic material such as polyvinyl chloride (PVC), approximately 0.0105 inches in thickness, but also incorporating an additive within the material 80 itself to provide a photochromic (or “photochromatic” or “photosensitive”) characteristic as described hereinabove with reference to FIG. 1, employing either known or hereinafter developed technology.

Thus, commercially-available UV-activated photochromic dyes are employed, selected and balanced in view of the desired color, in combination with a stabilizer package for longevity. In view of UV-attenuation characteristics of various automobile window glass formulations, it is preferable that particular dyes be selected which are activated at relatively longer wavelengths transmitted through the window glass. As is known, particular dyes and stabilizers are selected as a compromise to achieve a desired ability to darken as well as stability over time. A dye formulation may be selected which has a slight residual color. Suitable photochromic dyes are commercially available from PPG Industries, Keystone Aniline Corporation, and James Robinson (UK). The concentration of dye in PVC may range from about 0.05% up to about 1% by weight, with a preferred range of from about 0.05% up to about 0.2% by weight. Known types of stabilizers include and are generically known as Hindered Amine Light Stabilizer (HALS), UV absorber, and anti-oxidant. Stabilizers are commercially available from CIBA-Giegy. The concentration of stabilizer in PVC may range from about 0.1% up to about 3% by weight, with a preferred range of from about 0.2% up to about 0.5% by weight.

In view of the foregoing, it will be appreciated that the invention is embodied in sunshades that attach to a side window or the rear window of an automobile or other vehicle, particularly for shading an infant riding in a child car safety seat from the sun. Sunshades embodying the invention have a photochromic characteristic, much like photochromic eyeglasses which automatically darken when required to serve as sunglasses, so as to automatically increase the shading of the infant when required.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

1. A vehicle sunshade comprising a sheet of generally transparent flexible shading material which self-adheres to the interior side of a vehicle window, said sheet of shading material having a photochromic characteristic such that said sunshade turns relatively darker when exposed to sunlight and relatively lighter or more transparent when the intensity of sunlight decreases.

2. The sunshade of claim 1, wherein said shading material comprises a plastic sheet having a photochromic film applied to a surface of said plastic sheet.

3. The sunshade of claim 1, wherein said shading material comprises a photochromic plastic sheet including an additive within said photochromic plastic sheet to provide the photochromic characteristic.

4. A vehicle sunshade comprising:
a sheet of generally transparent flexible shading material; and
an attachment for attaching said sheet of generally transparent flexible shading material to the interior side of a vehicle window;
said sheet of shading material having a photochromic characteristic such that said sunshade turns relatively darker when exposed to sunlight and relatively lighter or more transparent when the intensity of sunlight decreases.

5. The sunshade of claim 4, wherein said shading material comprises a photochromic plastic sheet including an additive within said photochromic plastic sheet to provide the photochromic characteristic.

6. The sunshade of claim 4, wherein said attachment comprises suction cups.

7. The sunshade of claim 4, which is a roller shade and wherein said attachment comprises suction cups.

8. The sunshade of claim 4, which is a pop-open shade and wherein said attachment comprises a frame-like snap action border.

9. The sunshade of claim 5, wherein said attachment comprises suction cups.

10. The sunshade of claim 5, which is a roller shade and wherein said attachment comprises suction cups.

11. The sunshade of claim 4, which is a pop-open shade and wherein said attachment comprises a frame-like snap action border.
